(19) United States
(12) Patent Application Publication
(10) Pub. No.: US 2011/0244145 A1
(43) Pub. Date: Oct. 6, 2011

(54) IRON PARTICULATE-REINFORCED TIN BASED MATRIX COMPOSITE SOLDER BALL AND FLIP CHIP BALL PLACEMENT METHOD USING SAME

(76) Inventor: SHIUAN-SHENG WANG, Taipei City (TW)

(21) Appl. No.: 12/750,712

(22) Filed: Mar. 31, 2010

(51) Int. Cl. B05D 5/12; B23K 35/04

(52) U.S. Cl. 427/598; 228/56.3

(57) ABSTRACT

The present invention provides an iron particulate-reinforced tin based matrix composite alloy tin solder ball and a flip chip ball placement method using the same. A tiny metal iron particle is added in an alloy solder ball to form an alloy solder ball containing iron powder, whereby magnetic equipment can be used to attract and effectively hold the composite alloy solder ball so as to help positioning of a micro alloy solder ball in a flip chip ball placement process by securely attracting and filling the ball in a cavity defined in a stencil. By further employing a proper ball removal process to remove excessive alloy solder balls, the cluster aggregation phenomenon caused by surface moisture absorption and electrostatic force of the micro alloy solder ball can be eliminated to allow for smooth placement of balls and improve the bonding between a micro circuit board substrate and electronic components.

### (a) TECHNICAL FIELD OF THE INVENTION

The present invention generally relates to an iron particulate-reinforced tin based matrix composite alloy solder ball and a flip chip ball placement method using same, which is technology applicable to flip chip package for performing most effective soldering operation through placement of alloy solder balls containing iron particulates therein on a circuit board substrate.

### (b) DESCRIPTION OF THE PRIOR ART

Recently, electronic packaging technology is subjected to impacts from the upstream side, which continuously improves the capability of chip design and manufacturing to provide electronic components of high density, high I/O count, high speed, and high power, and the downstream side, where the general consumers increasingly demand for electronic products of light weight and compactness. Thus, the electronic packaging industry has to devote themselves to the development of new technology for realization of miniaturization, improved product yield, increased heat dissipation, reduced cost, and enhanced reliability in order to meet the need of market. For high density packaging, flip chip is now one of the most important bonding processes. Due to the features of self-alignment and reworkability offered by solder, most of the bumps of flip chips are formed of solder material, but the key technical issues are formation and assembling of solder bumps. Conventional ways of forming solder bumps include electroplating and stencil printing of solder paste. The electroplating method causes problems associated with environmental conservation and also surfer the difficult of performance of electroplating solder of specific alloy components. More importantly, European Union require the use of lead free solder, which makes the formula of electroplating solution, electroplating parameters, and stability hard to control and also needs a great expense for masks. All these make the method not fit for the needs of market popularity and low cost. As a consequence, most of the package manufacturers are now gradually turning to solder paste stencil printing process for making flip chip package. However, when the size of the flip chip bump is reduced to less than 0.1 mm, each single solder pump is constituted by only a few solder particles, even the solder powders used are of a diameter of around 10 μm. This will lead to poor chip coplanarity after reflow because of the inconsistent size of the solder spots. If solder powders of even smaller sizes are used, there are also problems to be addressed, including powder spraying, oxidizing, size sieving, and powder dust pollution. On the other hand, using solder paste to form flip chip bumps often leads to the formation of voids inside the solder after reflow of reflux. All these issues are severe challenges to the process of applying solder paste stencil printing to form flip chip bumps. Thus, to solve the problem of poor application of solder paste in fine pitch (below 0.1 mm) process, the up-to-date solution is to carry out ball placement and reflow by directly using micro alloy solder ball (smaller than 0.1 mm) in order to form flip chip bumps. However, the ball placement process of micro solder balls faces a challenge of overcoming the influences caused by surface moisture absorption and electrostatic force of the solder balls in order to precisely place a solder ball in a correct site by overcoming.

### SUMMARY OF THE INVENTION

The present invention provides an iron particulate-reinforced tin based matrix composite alloy solder ball and a flip chip ball placement method using the same, wherein a tiny iron particle is added and contained in a solder ball to make an alloy solder ball that contains an iron powder and a magnet can be applied to attract and hold the whole composite alloy solder ball. Such a feature effectively helps positioning of a micro alloy solder ball to have the solder ball securely attracted and filling into a cavity formed in a ball placement stencil. By further employing a vacuum ball removal process to suck and remove excessive alloy solder balls, cluster aggregation phenomenon caused by surface moisture absorption and electrostatic force induced by the micro alloy solder balls can be eliminated and smooth performance of ball placement can be realized. In other words, a purpose of the present invention is to make an alloy solder ball that contains iron powder and to apply the alloy solder ball to a flip chip ball placement process, in order to effectiveness of flip chip and simplify the process and also to improve bonding strength between a circuit board substrate and components that are bonded together.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view illustrating a ball placement process according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention includes two stages of technical feature. One is to mix iron particulates in an alloy solder ball to form a composite alloy tin solder ball structure for improving the bonding strength between a circuit board substrate and an electronic component. Then, the alloy tin solder ball is applied to flip chip ball placement technology to thereby realize simplification of the process.

In respect of the manufacturing of the iron powder-tin based alloy solder ball, since iron has very low solubility and diffusibility in solder, there will be no concern of coarsening. According to published papers, adding iron may effectively increase the normal temperature tensile strength of solder and is more significant in resisting creeping in high temperature, which is about five time of the solder containing no strengthening phase particles. To improve the wettability of iron and solder, according to a preferred embodiment of the present invention, the surface of iron powder is first coated with a layer of tin to form FeSn₂ intermetallic compound on the surface. This process is complicated but allows for easy mixture of iron particulates and tin melt. For uniform distribution, an environment containing magnetic field can be used. Further, the present invention may also adopt a chemical plating process and the reasons are that chemical plating requires no additional supply of electricity and thus there will be problems caused by interruption of electricity supply or non-uniform distribution. Thus, the coating layer is uniform and planar. The reducer contained in the plating solution help reducing and depositing tin ions on the surface of the iron powder, and the surface feature catalysis of reaction of tin, so that after the first layer of tin has been coated, the first layer helps catalyzing the reduction and deposition of the next layer of tin. It is this phenomenon that the chemical tin plating is also referred to as autocatalytic plating. Further, according to the present invention, in the manufacturing of iron particle strengthened lead-free composite tin solder, a Sn₃Ag_{0.5}Cu solder bar is used to combine with iron particles that have tin surface coating to form a composite tin alloy solder, which is used to make composite tin solder of different ratio of content of iron particles in order to improve solder thermo-mechanical strength.

The manufacturing process starts with coating a layer of chemical tin on the surface of iron powder. Chemical tin is formed through chemical reduction of metal ions contained in an aqueous solution in a controlled environment, whereby metal tin can be plated on the iron powder without an external supply of electricity and the plating layer so formed is continuous and autocatalytic. The formula for chemical plating solution must show the following characteristics: oxidation reduction potential must be sufficient for reduction of metal ions in order to precipitate the metal; a stable plating bath must be established, which shows no reaction before being used and starts reaction only when put in contact with catalytic surface of object to be coated in order to carry out quick precipitation of metal layer; precipitation rate must be controllable, where pH value and temperature can regulate the precipitation rate; metal precipitation must show capability of catalysis in order to cause autocatalysis for continuous formation of plating layer to reach a desired thickness of the plating layer; and reaction product of the plating solution must cause no interference with the function of the plating solution in order to extend the service life of the plating solution.

Before the process of chemical tin plating is carried out, in an example of the present invention, a degreasing agent is first applied to clean the iron powder. The degreasing agent can be a mixed liquid of acidic solution and surfactant and the operation temperature is 50° C., immersion time being 1 minute. Afterwards, deionized water is used to rinse the iron powder. Then, micro-etchant is applied to roughen the surface of iron powder in order to enhance surface adhesion of tin. The time of micro etching is 5 seconds. To prevent the chemical tin plating solution in the primary plating tank from being contaminated or diluted, pre-soaking of the iron powder in additional chemical tin plating solution is done first for 1 minute, and this helps prevent the iron powder from inducing direct reaction with the plating solution of the primary tank so as to maintain the acid equivalent and tin equivalent. Chemical tin is plated on the surface of iron powder through substitution reaction. Afterwards, the specimen on which the chemical plating is finished is immersed in ethyl alcohol for cleaning for 2 minutes and then rinsed two to three times with hot water to completely remove residual of chemical tin plating solution from the specimen. Finally, the iron powder is dried. The iron powder, with the tin plating completed, is uniformly mixed with melt of Sn₃Ag_{0.5}Cu to form a composite alloy tin solder ball. This completes the manufacturing process of the present invention for making the alloy tin solder ball containing iron component therein.

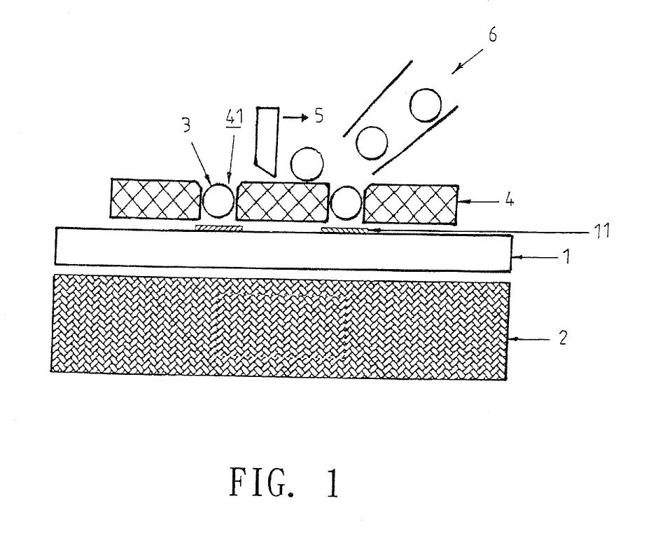

As to ball placement of micro solder balls sized below 0.1 mm, to state-of-the-art method is using a stencil to carry out screen printing of reflux and then using a specific technique to fill micro solder balls in cavities formed in the stencil to carry out reflow ball placement operation, whereby high density of contacts of solder ball: 80 μm/pitch: 150 μm can be realized on a wafer; or alternatively, a high precision ultra-micro tube is used to convey solder balls, so that when the solder ball reaches an outlet where a solder pad is located, a laser beam is applied to quickly heat the solder, making it melted on the solder pad of a chip. The more severe challenge that the placement process of micro solder balls faces is cluster aggregation caused by surface moisture absorption and electrostatic force induced by miniaturization of solder balls. Thus, handling and controlling of micro solder balls is a key issue of the ball placement process and the conventional manners provide no effective control at all. To overcome such problems of placement of micro solder balls, the present invention uses the metal iron particle composite alloy tin solder balls that as discussed previously are magnetically attractable. Referring to FIG. 1, the flip chip ball placement method of the present invention is as follows. Below a substrate 1, a magnetic member 2 is arranged to provide magnetic attraction force for holding an alloy solder ball 3 and leading the alloy solder ball 3 into a micro cavity 41 formed in a stencil 4 and located above a solder pad 11 of the substrate 1. Afterwards, a vacuum ball removal device 5 or a scraper 6 is employed to remove excessive alloy solder balls 3 from the surface of the stencil 4, by which the process of ball placement is completed. In this process, due to the action provided by the magnetic attraction, the cluster aggregation phenomenon caused by surface moisture absorption and electrostatic force of the surface of the micro alloy solder ball 3 can be eliminated to allow smooth placement of the ball on the substrate 1 for subsequent soldering operation to complete the following process.

A circuit board substrate that is completed with the above discussed ball placement operation provides excellent bonding strength for components mounted thereon and test result of impact reliability test, which is carried out by applying repeated dropping impact from different heights and directions with additional loading, shows the soldering strength for a product completed with the present invention is far superior to any product using the conventional solder bumps.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An iron particulate-reinforced tin based matrix composite alloy solder ball comprising a tiny iron particle contained inside the solder ball.

2. A flip chip ball placement method, which uses the alloy solder ball according to claim 1 as a ball to be placed, wherein a magnetic member is arranged below a substrate to provide a magnetic attraction force to hold the alloy solder ball so as to cause the alloy solder ball to fill into a cavity defined in a stencil at a location above a solder pad of the substrate and a ball removal device is employed to remove an excessive alloy solder ball from the stencil to thereby complete the ball placement process.
